(19) United States
(12) Patent Application Publication
(10) Pub. No.: US 2020/0253234 A1
(43) Pub. Date: Aug. 13, 2020

(54) WHIPPED ICE CREAM MIX

(71) Applicant: DIPPIN' DOTS, L.L.C., PADUCAH, KY (US)

(72) Inventor: Stan Jones, Vienna, IL (US)

(21) Appl. No.: 16/647,950

(22) PCT Filed: Sep. 25, 2018
(86) PCT No.: PCT/US2018/052594

§ 371 Date: Mar. 17, 2020

Related U.S. Application Data
(60) Provisional application No. 62/564,053, filed on Sep. 27, 2017.

(51) Int. Cl. A23G 9/08; A23G 9/22; A23G 9/28; A23G 9/46; B65D 83/20

(52) U.S. Cl. CPC A23G 9/083; A23G 9/221; B65D 83/202; A23G 9/46; A23G 9/28

(57) ABSTRACT

System and methods concerning easy preparation of frozen food treats and in particular, frozen food treats that are molded into desirable and fun shapes. The system and methods are directed to dispensing a treat formulation into molds. Generally, such methods and systems utilize a pressurized canister, a treat formulation and an actuator. The pressurized canister has a pressure-actuated nozzle. The treat formulation can be blended and compressed into the pressurized canister with a gaseous propellant. The treat formulation can contain a dairy cream or a non-dairy cream, and two or more of sugar, sweetened condensed milk, vanilla and egg. The actuator is configured to apply pressure to the nozzle so as to trigger the release of the treat formulation through the nozzle.

### CROSS REFERENCE TO RELATED APPLICATION

This application claims the benefit of U.S. Provisional Patent Application No. 62/564,053 filed on Sep. 27, 2017.

### FIELD

The present disclosure relates generally to the field of frozen treats such as ice cream, gelato, frozen yogurt and frozen custard, and more specifically, to the preparation of such frozen treats for use.

### BACKGROUND

Children are particularly fond of kitchen apparatuses designed for use by children and toys related to food preparation. Additionally, such apparatuses and toys are good for child development because they are relatively close to life, stimulate children in hands-on production of various types of food, cater to a child's interests, and also can improve the practical ability and creative consciousness of children.

Ice cream is a particularly popular food item for kids and ice cream production process can also be very fun. Unfortunately, ice cream production can be complicated and difficult. The original method of making “homemade” ice cream involves measuring the appropriate amount of cream, milk, sugar and flavor into a suitable blend, and depending on the recipe, may require cooking on the stove. Afterwards, the blend is placed in a container, which is surrounded by a mixture of salt (e.g., rock salt) and cracked ice. The contents are stirred for an extended period during which, the presence of the salt causes the ice to melt and absorb heat from the container thereby causing the contents of the container to convert to ice cream. The container and surrounding mixture must be monitored during the freezing process to ensure that the contents are continuously stirred and to add additional ice and salt. This process can be messy and tedious for young kids and does not lend itself readily to creating fun shapes out of the ice cream.

### SUMMARY

The present disclosure relates to apparatuses and methods for easy preparation of frozen food treats and in particular, frozen food treats that are molded into desirable and fun shapes. For example, some embodiments of this disclosure are directed to a system for dispensing a treat formulation. The system comprises a pressurized canister, a treat formulation and an actuator. The pressurized canister has a pressure-actuated nozzle. The treat formulation can be blended and compressed into the pressurized canister with a gaseous propellant. The treat formulation can contain a dairy cream or a non-dairy cream, and two or more of sugar, sweetened condensed milk, vanilla and egg. The actuator is configured to apply pressure to the nozzle so as to trigger the release of the treat formulation through the nozzle.

In some of these embodiments, the actuator comprises a stand, a lever and a plunger. The stand suspends the pressurized canister over a mold and provides a pivot point for the lever. The plunger engages the pressurized canister upon movement of the lever about the pivot point so that pressure is applied to the nozzle when the lever is pressed.

In other of these embodiments, the actuator comprises a stand and a screw press. The stand suspends the pressurized canister over a mold and provides a screw mount for the screw press. The screw press applies pressure to the nozzle when a wheel is turned.

The system can further comprise a mold for the treat formulation. The actuator suspends the pressurized canister over the mold so that treat formulation released through the nozzle enters the mold. The mold can be a three-dimensional mold so to mold the treat formulation into a shape selected from the group comprising an animal shape, a geometric shape and a flower blossom.

In other embodiments, there is provided a method for preparing a frozen treat formulation. The method comprises the steps of:
providing a pressurized canister having a pressure actuated nozzle and containing a treat formulation, wherein the treat formulation is a blend of a dairy cream or a non-dairy cream, and two or more of sugar, sweetened condensed milk, vanilla and egg and is compressed into the pressurized canister with a gaseous propellant, optionally other formulations may be used;
applying pressure to the pressure actuated nozzle so as to trigger the release of the treat formulation through the nozzle and into the mold; and
subjecting the treat formation in the mold to a temperature below the freezing point of the treat formation to produce the frozen treat formation.

The method can further comprise the step of positioning the pressurized canister over a mold such that the nozzle is aligned with the mold so that, in the step of applying pressure, treat formulation flows from the nozzle into the mold. Typically, the gaseous propellant causes the formulation to expand into the mold.

In the method, the step of positioning the pressurized container over the mold comprises placing the pressurized canister onto a stand and engaging an actuator with the pressurized canister such that movement of the actuator applies pressure to the nozzle so as to trigger the release of the treat formulation from the pressurized canister.

### BRIEF DESCRIPTION OF THE DRAWINGS

FIG. 1 is a schematic prospective illustration of one embodiment of a device for distributing mixture from a pressurized canister into a tray for creating specialty frozen treat products.

FIG. 2 is a schematic illustration of an embodiment of a device for releasing a pressurized mixture from a canister.

FIG. 3 is a schematic illustration of a second embodiment of a device for releasing a pressurized mixture from a canister.

### DETAILED DESCRIPTION

The present disclosure may be understood more readily by reference to the following detailed description and figures. In addition, numerous specific details are set forth in order to provide a thorough understanding of the embodiments described herein. However, those of ordinary skill in the art will understand that the embodiments described herein can be practiced without these specific details. In other instances, methods, procedures and components have not been described in detail so as not to obscure the related relevant feature being described.

This disclosure concerns pressurized canisters of pre-prepared mixtures (treat formulations) that are prepared to be frozen to make treats such as ice cream, gelato, frozen yogurt and frozen custard. For example, such pre-prepared mixtures can comprise two, three or more of cream, sweetened condensed milk, non-dairy vegetable fat type cream (non-dairy cream), sugar, eggs, vanilla, flavorings and similar so that the mixture can be frozen to produce a frozen treat without additional ingredients; however, in some cases chocolate chips, nuts, raisins or similar solid foods might be added to the pre-prepared treat formulation prior to freezing. Typically, the pre-prepared treat formulation will comprise at least one of cream and non-dairy cream, and two or more of sugar, sweetened condensed milk, vanilla and egg. In one particular embodiment, the treat formulation comprises from 0.5 to 40% butterfat or non-dairy creamer, and from 2 to 20% sugar; more preferably the treat formulation is at least 10%, at least 20%, at least 30%, or even at least 35% butter fat or non-dairy creamer. Also, more preferably the treat formulation is at least 5%, at least 10% or at least 15% sugar.

The ingredients for the treat formulation are blended together, placed into a canister, and pressurized. The pressurized canister is an aerosol type canister pressurized with a propellant, such as nitrous oxide, nitrogen, carbon dioxide and mixtures thereof, under considerable pressure. Generally, the propellant will dissolve in the treat formulation in the canister, and upon dispersing from the canister, the propellant separates out from the pre-prepared mixture causing blending and foaming. Thus, the dispersing from the canister is sometimes referred to as “foaming”.

This type of pressurized canister can be similar to those known in the art for whipped cream. The pressurized canister typically has a pressure-actuated nozzle, such as known in the art. For example, a pressure-actuated nozzle as disclosed in U.S. Pat. No. 5,553,755.

This canister of treat formulation can be packaged in multiple sizes. The product can be sold to the home purchaser for homemade frozen treats at home, by foaming or distributing the treat formulation from the pressurized container into a mold or other container suitable for freezing the treat formulation. Typically, the gaseous propellant not only causes the treat formulation to foam from the nozzle of the canister but also causes the formulation to expand into the mold.

The mold can provide for multiple shapes or sizes such that the final frozen treat can have a desirable shape, such as balls or dots, stars, animal shapes, geometric shapes, flower blossoms and many more shapes of various sizes. Once in the mold or other container, the filled container of the treat formulation can be placed into a household freezer at temperature at or below the freezing point of the treat formulation. The filled container stays in the freezer until frozen, typically about 2 to 4 hours. The mold or containers could also be distributed commercially for use in restaurants or other retail locations doing business in the food industry.

In one embodiment, the pressurized ingredients can be packaged into canisters that would be a part of a toy dispensing system for children to make their own ice cream and specifically to make novelty frozen treats having specialty sizes and shapes. As indicated above, other shapes can also be used for the novelty-frozen treats such as animal shapes, geometric shapes, flower blossoms and many more shapes of various sizes.

In some embodiments, the toy dispensing system includes a stand and an actuator. The stand is configured to suspend the pressurized canister over a mold. The actuator is typically configured to interact with the stand or be mounted on the stand, and is configured to engage with the pressurized canister so as to apply pressure to the nozzle thus triggering the release of the treat formulation through the nozzle of the canister. For example, the canister of pressurized treat formulation can be placed in a hand press, or a gun type dispenser where a trigger is squeezed to dispense the canister or a wheel attached to a threaded screw that increases the pressure as the wheel is so that the pressurized contents are released into a mold that has multiple dimensional cavities that fill under the pressure of the canister being released. The mold is then placed in the freezer until frozen and ready to serve.

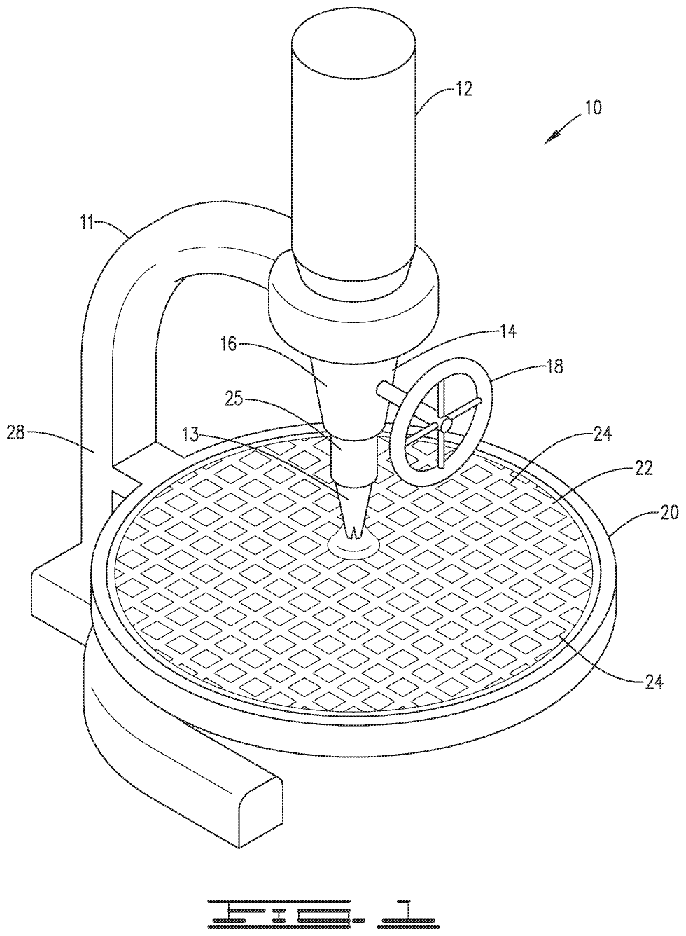

Various toy systems for children to make their own novelty ice cream products at home can be devised with the above outlined system. One example is illustrated in FIG. 1 as system 10. In system 10, a canister 12 is placed into a holder 14 of stand 11, such that the canister's nozzle interacts with releaser 16, which is illustrated with wheel actuator 18. Wheel actuator 18 can have a graduated movement such that greater degrees of turn result in a greater flow of treat formulation from the canister. Thus, the flow can be controlled.

System 10 further includes a table 20 which holds a mold 22 under the dispenser 25 so that treat formulation being dispensed is introduced to mold 22 such that cavities 24 in mold 22 can be filled. The cavities will be shaped so as to provide the desired shape to the final frozen treat product.

The nozzle on dispenser 25 will typically be inserted into mold 22 so as to channel the dispensed pre-prepared mixture from dispenser 25 to mold 22. A gaseous propellant foams the treat formulation while propelling it from the canister into the mode and expanding the foamed treat formulation throughout the mold with a minimum of splashing and runoff. Thus the treat formulation foams into the mold filling all voids of the mold. Generally, nozzle 13 will be positioned so as to inject into the mold cavity. Further, stand 11 can include a base 28. Table 20 and holder 14 are connected to base 28 so that they are held stationary in the correct relative position to each other during dispensing.

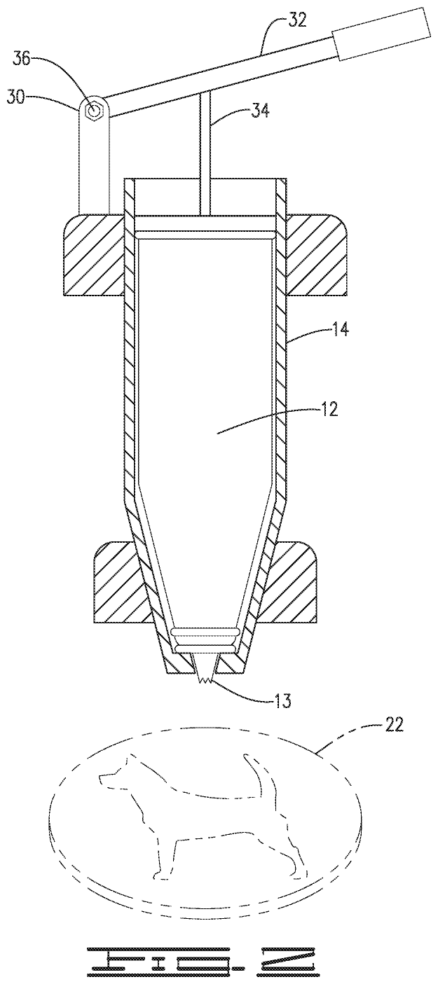

Another embodiment is illustrated schematically in FIG. 2, the holder 14 of a stand receives canister 12. An actuator 30 is connected to holder 14. Actuator 30 comprises a lever 32 and a plunger 34. Holder 14 and actuator 30 are connected such that holder 14 provides a pivot point 36 for lever 32. Plunger 34 engages pressurized canister 12 so that, upon movement of lever 32 about pivot point 36, pressure is applied to nozzle 13 and the treat formulation is released through nozzle 13 into mold 22.

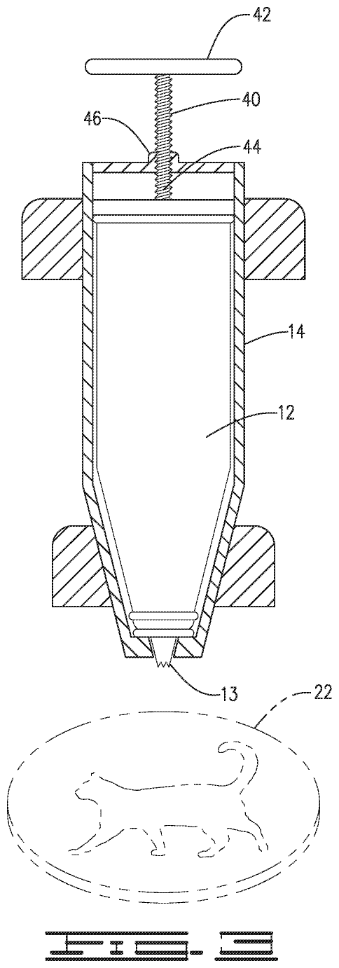

A further embodiment is illustrated schematically in FIG. 3, the holder 14 of a stand receives canister 12. An actuator 40 is connected to holder 14. Actuator 40 comprises a wheel 42 and a thread press 44. Holder 14 and actuator 40 are connected such that holder 14 provides a screw mount 46 for thread press 44. Wheel 42 is used to turn thread press 44 so that it moves downward. Thread press 44 engages pressurized canister 12 so that, upon movement of thread press 44, pressure is applied to nozzle 13 and the treat formulation is released through nozzle 13 into mold 22.

The above systems lend themselves readily to a method for preparing a frozen treat formulation. Generally, the method comprises first providing a pressurized canister having a pressure-actuated nozzle and containing the treat formulation. The canister is then placed into the holder of the system and the actuator is engaged with the canister. Either before or after placement of the canister, a mold is selected and placed into positon with relation to the stand so that it can receive treat formulation released from the canister. After the mold is aligned with the canister in the holder, pressure is applied so as to activate the nozzle thus triggering the release of the treat formulation through the nozzle and into the mold. After the mold has been filled to a predetermined level, the mold containing the treat formulation is subjected to a temperature below the freezing point of the treat formation to produce the frozen treat formation.

Molds for this type of homemade ice cream can be formed into any three-dimensional shape where the treat formulation can flow into a cavity and be molded into various shapes, such as animal shapes, geometric shapes, flower blossoms and others. The treat formulation in the pressurized canisters can be made into different flavors or blended with more than one flavor per mold. Additionally, such treat formulation in canisters are convenient to use and extend the shelf life of the pre-prepared mixtures so that they can have a shelf life of 6 months or more.

Upon review of the above, various embodiments will be readily apparent. In one embodiment, there is provided a frozen treat formulation blended and compressed into a pressurized canister, wherein said frozen treat formulation contains a dairy cream or a non-dairy cream and two or more of sugar, sweetened condensed milk, vanilla and eggs.

In another embodiment, there is provided a pressurized canister of a pre-prepared mixture (treat formulation) with a refrigerated shelf life of 6 months, wherein the pre-prepared mixture contains a dairy cream or a non-dairy cream and two or more of sugar, sweetened condensed milk, vanilla and eggs. Although the process and apparatuses of the current disclosure are especially useful for the afore-described pre-prepared mixture, they are not limited to such mixtures and can also work with other treat formulations, which do not contain dairy cream or non-dairy cream.

In a further embodiment, there is a dispensing device for dispensing a canister, such as described in the above embodiments into a three-dimensional mold. In some of these embodiments, the dispensing device is a hand-press lever action-dispensing device. In other embodiments, the dispensing device is a gun-style trigger dispenser device. In yet other embodiments, the dispensing device is a screw-press dispensing device.

Therefore, the present invention is well-adapted to attain the ends and advantages mentioned as well as those that are inherent therein. The particular embodiments disclosed herein are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a to b”) disclosed herein is to be understood to set forth every number and range encompassed within the broader range of values. Additionally, where the term “about” is used in relation to a range, it generally means plus or minus half the last significant figure of the range value, unless context indicates another definition of “about” applies.

Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A system for dispensing a treat formulation, the system comprising:
a pressurized canister having a pressure-actuated nozzle;
the treat formulation, which is blended and compressed into the pressurized canister with a gaseous propellant, wherein the treat formulation contains a dairy cream or a non-dairy cream, and two or more of sugar, sweetened condensed milk, vanilla and egg; and
an actuator configured to apply pressure to the nozzle so as to trigger the release of the treat formulation through the nozzle.

2. The system of claim 1, wherein the actuator comprises a stand, a lever and a plunger, and wherein the stand suspends the pressurized canister over a mold and provides a pivot point for the lever, and the plunger engages the pressurized canister upon movement of the lever about the pivot point so that pressure is applied to the nozzle when the lever is pressed.

3. The system of claim 1, wherein the actuator comprises a stand and a screw press, and wherein the stand suspends the pressurized canister over a mold and provides a screw mount for the screw press, and the screw press applies pressure to the nozzle when a wheel is turned.

4. The system of claim 1, further comprising a mold for the treat formulation, and wherein the actuator suspends the pressurized canister over the mold so that treat formulation released through the nozzle enters the mold.

5. The system of claim 4, wherein the mold is a three-dimensional mold so to mold the treat formulation into a shape selected from the group comprising an animal shape, a geometric shape and a flower blossom.

6. The system of claim 4, wherein the actuator is lever actioned so as to apply pressure to the nozzle when a lever is pressed.

7. The system of claim 6, wherein the actuator comprises a stand, the lever and a plunger, wherein the stand suspends the pressurized canister over the mold and provides a pivot point for the lever, and the plunger engages the pressurized canister upon movement of the lever about the pivot point so as to apply pressure to the nozzle.

8. The system of claim 4, wherein the actuator is a screw press which applies pressure to the nozzle when a wheel is turned.

9. The system of claim 8, wherein the actuator comprises a stand and the screw press, wherein the stand suspends the pressurized canister over the mold and provides a screw mount for the screw press.

10. A method for preparing a frozen treat formulation, the method comprising:
providing a pressurized canister having a pressure-actuated nozzle and containing a treat formulation, wherein the treat formulation is a blend of a dairy cream or a non-dairy cream, and two or more of sugar, sweetened condensed milk, vanilla and egg and is compressed into the pressurized canister with a gaseous propellant;
applying pressure to the pressure actuated nozzle so as to trigger the release of the treat formulation through the nozzle and into the mold; and
subjecting the treat formation in the mold to a temperature below the freezing point of the treat formation to produce the frozen treat formation.

11. The method of claim 10, further comprising the step of positioning the pressurized canister over a mold such that the nozzle is aligned with the mold so that, in the step of applying pressure, treat formulation flows from the nozzle into the mold.

12. The method of claim 11, wherein the step of positioning the pressurized container over the mold comprises placing the pressurized canister onto a stand and engaging an actuator with the pressurized canister such that movement of the actuator applies pressure to the nozzle so as to trigger the release of the treat formulation from the pressurized canister.

13. The method of claim 12, wherein the actuator has a lever and a plunger, and wherein the stand suspends the pressurized canister over a mold and provides a pivot point for the lever, and the plunger engages the pressurized canister upon movement of the lever about the pivot point so as to apply pressure to the nozzle when a lever is pressed.

14. The method of claim 12, wherein the actuator has a screw press, and wherein the stand suspends the pressurized canister over a mold and provides a screw mount for the screw press, and the screw press applies pressure to the nozzle when a wheel is turned.

15. The method of claim 12, wherein the mold is a three-dimensional mold so to mold the treat formulation into a shape selected from the group comprising an animal shape, a geometric shape and a flower blossom.
